(19) United States
(12) Patent Application Publication
(10) Pub. No.: US 2026/0322866 A1
(43) Pub. Date: Oct. 15, 2026

(54) OPTIMIZED CONDITIONAL TRANSACTIONS WITH UDR

(71) Applicant: Nokia Technologies Oy, Espoo (FI)

(72) Inventors: Pradyumna Ram PRASAD, Bangalore (IN); Muthuswamy SOMASKANDAN, Bangalore (IN); Harish MURALIDHARA, Bangalore (IN); Jonathan LITTLE, Bristol (GB)

(21) Appl. No.: 19/483,707

(22) PCT Filed: May 7, 2024
(86) PCT No.: PCT/EP2024/062593

§ 371 Date: Nov. 12, 2025

(30) Foreign Application Priority Data
May 12, 2023 (IN) 202341033648

(51) Int. Cl. H04L 67/02; G06F 16/907; G06F 16/9532

(52) U.S. Cl. CPC H04L 67/02; G06F 16/907; G06F 16/9532

(57) ABSTRACT

Various examples of embodiments described herein relate to methods and apparatuses for optimized conditional transactions. One such example of an embodiment relates to a method that includes providing a request, the request including a query parameter indicating a sub-resource for which an entity-tag value is requested. The method also includes receiving a response based on the request, the response including an entity-tag value for the indicated sub-resource. The method further includes performing subsequent conditional read and/or update of the sub-resource based on the entity-tag value included in the response.

### TECHNICAL FIELD

Various examples of embodiments described herein relate to a method and an apparatus for optimized conditional transactions (e.g., conditional transactions with improved efficiency) with a network entity or function (e.g., Unified Data Repository (UDR)).

### BACKGROUND

Over time, an increasing extension of communication networks has taken place all over the world. Various organizations, such as the European Telecommunications Standards Institute (ETSI), the 3^{rd} Generation Partnership Project (3GPP), Telecoms & Internet converged Services & Protocols for Advanced Networks (TISPAN), the International Telecommunication Union (ITU), 3^{rd} Generation Partnership Project 2 (3GPP2), Internet Engineering Task Force (IETF), the IEEE (Institute of Electrical and Electronics Engineers), the WiMAX Forum and the like are working on standards or specifications for telecommunication networks and access environments.

By way of example, 3GPP defines 5G Core Network Function's (NF's) interfaces and relevant Application Programming Interfaces (APIs) for each NF to communicate between NFs.

### SUMMARY

Various examples of embodiments described in the subject disclosure provide certain advantages, for example in the form of one or more improvements that are either explicitly described herein or otherwise apparent to a person skilled in the art from the subject disclosure. Hence, at least some examples of embodiments of the subject disclosure aim to provide (or otherwise contribute to) at least part of the aforementioned advantages and improvements.

Various aspects of examples of embodiments of the subject disclosure are set forth in the claims and pertain to methods, apparatuses and computer program products in the context of conditional transactions with a network entity or function (e.g., UDR).

At least some of aforementioned advantages and improvements may be achieved through the methods, apparatuses and non-transitory storage media as specified in the claims. Further advantages and improvements may be achieved through the methods, apparatuses and non-transitory storage media set forth in respective dependent claims.

Insofar, according to various examples of embodiments, a method may comprise:
providing a request, the request including a query parameter indicating a sub-resource for which an entity-tag value is requested; receiving a response based on the request, the response including an entity-tag value for the indicated sub-resource; and performing subsequent conditional read and/or update of the sub-resource based on the entity-tag value included in the response.

According to various examples of embodiments, the method may further comprise that the request may be an HTTP request and that the response may be an HTTP response.

According to various examples of embodiments, the method may further comprise that the request may be a GET request and that the response may be a GET response.

According to various examples of embodiments, the method may comprise that the providing may comprises including the query parameter in the request.

According to various examples of embodiments, the method may comprise that the providing may comprise providing the request for a resource, wherein the sub-resource for which the entity-tag value is requested is a sub-resource of the resource.

According to at least some examples of embodiments, a method may comprise:
receiving a request, the request including a query parameter indicating a sub-resource for which an entity-tag value is requested; including an entity-tag value for the indicated sub-resource in a response; and providing the response.

According to at least some examples of embodiments, the method may further comprise that the request may be an HTTP request and that the response may be an HTTP response.

According to at least some examples of embodiments, the method may further comprise that the request may be a GET request and that the response may be a GET response.

According to at least some examples of embodiments, the method may further comprise that the receiving may comprise receiving the request for a resource, wherein the sub-resource for which the entity-tag value is requested is a sub-resource of the resource.

According to at least some examples of embodiments, the method may further comprise that the including may comprise including a map in the response, where an identifier of a resource for which the request is received, the resource comprising the sub-resource, serves as key and where an entity-tag of the sub-resource serves as the entity-tag value.

According to at least some examples of embodiments, the method may further comprise that the including may comprise introducing and/or updating a header in the response to comprise the entity-tag value corresponding to the indicated sub-resource.

According to at least some examples of embodiments, the method may further comprise that the introduced and/or updated header may be in list form or in map form.

According to at least some examples of embodiments, the method may further comprise that the including may comprise including, in the response, an entity-tag value of each sub-resource in a corresponding resource for which the request is received.

According to at least some examples of embodiments, the method may further comprise that the providing may comprise providing a single entity-tag header with structured content comprising at least one member for each sub-resource in a corresponding resource for which the request is received.

According to various examples of embodiments, an apparatus, comprising at least one processor; and at least one memory storing instructions that, when executed by the at least one processor, may cause the apparatus at least to:
provide a request, the request including a query parameter indicating a sub-resource for which an entity-tag value is requested; receive a response based on the request, the response including an entity-tag value for the indicated sub-resource; and perform subsequent conditional read and/or update of the sub-resource based on the entity-tag value included in the response.

According to various examples of embodiments in relation to the apparatus, the request may be an HTTP request and the response may be an HTTP response.

According to various examples of embodiments in relation to the apparatus, the request may be a GET request, and the response may be a GET response.

According to various examples of embodiments, the apparatus may further be caused to provide the request may comprise to include the query parameter in the request.

According to various examples of embodiments, the apparatus may further be caused to provide the request may comprise to provide the request for a resource, wherein the sub-resource for which the entity-tag value is requested is a sub-resource of the resource.

According to at least some examples of embodiments, an apparatus, comprising at least one processor; and at least one memory storing instructions that, when executed by the at least one processor, may cause the apparatus at least to:
receive a request, the request including a query parameter indicating a sub-resource for which an entity-tag value is requested; include an entity-tag value for the indicated sub-resource in a response; and provide the response.

According to at least some examples of embodiments in relation to the apparatus, the request may be an HTTP request and the response may be an HTTP response.

According to at least some examples of embodiments in relation to the apparatus, the request may be a GET request and the response may be a GET response.

According to at least some examples of embodiments, the apparatus may further be caused to receive the request may comprise to receive the request for a resource, wherein the sub-resource for which the entity-tag value is requested is a sub-resource of the resource.

According to at least some examples of embodiments, the apparatus may further be caused to include the entity-tag value may comprise to include a map in the response, where an identifier of a resource for which the request is received, the resource comprising the sub-resource, serves as key and where an entity-tag of the sub-resource serves as the entity-tag value.

According to at least some examples of embodiments, the apparatus may further be caused to include the entity-tag value may comprise to introduce and/or update a header in the response to comprise the entity-tag value corresponding to the indicated sub-resource.

According to at least some examples of embodiments in relation to the apparatus, the introduced and/or updated header may be in list form or in map form.

According to at least some examples of embodiments, the apparatus may further be caused to include the entity-tag value may comprise to include, in the response, an entity-tag value of each sub-resource in a corresponding resource for which the request is received.

According to at least some examples of embodiments, the apparatus may further be caused to provide the entity-tag value may comprise to provide a single entity-tag header with structured content comprising at least one member for each sub-resource in a corresponding resource for which the request is received.

Any one of the aspects mentioned according to the claims facilitates conditional transactions with a network entity or function (e.g., UDR), thereby providing at least part of the aforementioned advantages and improvements.

In more detail, the subject disclosure describes conditional transactions with a network entity or function (e.g., UDR), which may, according to some examples of embodiments, prove advantageous over a proprietary solution for at least the following reasons.

Examples of embodiments described in the subject disclosure may, for instance, realize an increased efficiency, and an extension of network efficiency, of the NUDR interface in use cases where Etags for conditional reads and updates can be used. It is further noted that at least some of the solution options are also applicable (e.g., useable) with any other service-based interface that makes use of the Etag mechanism and conditional reads and updates.

Further advantages may become apparent to a person skilled in the art from the following detailed description.

### BRIEF DESCRIPTION OF THE DRAWINGS

Some examples of embodiments of the subject disclosure are described below, by way of example only, with reference to the accompanying drawings, in which:

FIG. 1 shows a signaling diagram, illustrating limitations with certain Etag solutions;

FIG. 2 (including part 1 of 2 and part 2 of 2) shows a signaling diagram, illustrating an example flow(s) according to various examples of embodiments of the subject disclosure;

FIG. 3 shows a flowchart illustrating steps corresponding to an example method according to various examples of embodiments of the subject disclosure;

FIG. 4 shows a flowchart illustrating steps corresponding to an example method according to various examples of embodiments of the subject disclosure;

FIG. 5 shows a block diagram illustrating an example apparatus according to various examples of embodiments of the subject disclosure; and

FIG. 6 shows a block diagram illustrating an example apparatus according to various examples of embodiments of the subject disclosure.

### DETAILED DESCRIPTION

In general, two or more end points involved in a communication therebetween may be implemented as a particular type of end point (e.g. a communication station or element or function, such as a terminal device, user equipment (UE), or other communication network element, a database, a server, host, etc.), or as one or more network elements or functions (e.g. virtualized network functions), such as communication network control elements or functions, for example access network elements like access points (APs), radio base stations (BSs), relay stations, eNBs, gNBs etc., and core network elements or functions, for example control nodes, support nodes, service nodes, gateways, user plane functions, access and mobility functions, etc., These end points may belong to a single communication network system, different communication network systems, or a combination of at least one same communication network system and at least one different communication network system.

In the following, various examples of embodiments will be described using, as an example of a communication network to which examples of embodiments may be applied, a communication network architecture based on 3GPP standards for a communication network, such as a 5G/NR, without restricting the examples of embodiments to such an architecture. It, however, is obvious for a person skilled in the art that the examples of embodiments may also be applied to other kinds of communication networks like 4G and/or LTE (and even 6G and higher) where mobile communication principles are integrated, e.g. Wi-Fi, worldwide interoperability for microwave access (WiMAX), Bluetooth®, personal communications services (PCS), ZigBee®, wideband code division multiple access (WCDMA), systems using ultra-wideband (UWB) technology, mobile ad-hoc networks (MANETs), wired access, etc. Furthermore, without loss of generality, the description of some examples of embodiments is related to a mobile communication network, but the subject disclosure can be extended and applied to any other type of communication network, such as a wired communication network or datacenter networking.

The following examples of embodiments are to be understood only as illustrative in nature. Although portions of the subject disclosure may refer to the expressions “an”, “one”, or “some” example(s) of embodiment(s) in several specific locations, this does not necessarily mean that each such reference is related to the same example(s) of embodiment(s), or that the described feature only applies to a single example of an embodiment. Individual features from different examples of embodiments may also be combined to provide other examples of embodiments. Furthermore, terms like “comprising” and “including” should be understood as not limiting the described examples of embodiments to consist of only those features that have been mentioned; such examples of embodiments can also contain features, structures, units, modules etc. that have not been specifically mentioned.

A simplified system architecture of a (tele) communication network including a mobile communication system, where some examples of embodiments, are applicable may include an architecture of one or more communication networks. The one or more communication networks may include wireless access network subsystem(s) and core network(s). Such an architecture may include one or more communication network control elements or functions, access network elements, radio access network elements, access service network gateways or base transceiver stations, such as a base station (BS), an access point (AP), a NodeB (NB), an eNB or a gNB, a distributed or a centralized unit (CU), which controls a respective coverage area or cell(s) and with which one or more communication stations such as communication elements or functions, like user devices (e.g. customer devices), mobile devices, or terminal devices, like a UE, or another device having a similar function, such as a modem chipset, a chip, a module etc., which can also be part of a station, an element, a function or an application configured to conduct a communication, such as a UE, an element or function usable in a machine-to-machine communication architecture, or attached as a separate element to such an element, function or application capable of conducting a communication, or the like, are configured to communicate via one or more channels via one or more communication beams for transmitting several types of data in a plurality of access domains. Furthermore, (core) network elements or network functions ((core) network control elements or network functions, (core) network management elements or network functions), such as gateway network elements/functions, mobility management entities, a mobile switching center, servers, databases and the like may be included.

Functions and interconnections of the described elements and functions, which also depend on the actual network type, are apparent to those skilled in the art and may be described in corresponding specifications, so that a description thereof is omitted herein. However, it is to be noted that several additional network elements and signaling links may be employed for a communication to or from an element, function or application, like a communication endpoint, a communication network control element, such as a server, a gateway, a radio network controller, and other elements of the same or other communication networks besides those described in detail herein below.

It should be appreciated that according to some examples of embodiments, a so-called “liquid” or flexible network concept may be implemented where the operations and functionalities of a network element, a network function, or of another entity of the network, may be performed in different entities or functions, such as in a node, host or server, in a flexible manner. Thus, a “division of labor” between involved network elements, functions or entities may vary case by case.

The subject disclosure, in some examples of embodies, relates to optimized conditional transactions (e.g., conditional transactions with improved efficiency) over Network Unified Data Repository (NUDR) interface defined in TS 29.505. Although certain examples of embodiments described in the subject disclosure detail the NUDR service, the subject disclosure is generally applicable to any or all service-based interfaces that make use of the entity-tag (Etag) mechanism and conditional reads and updates.

The Etag header in a GET response from Unified Data Repository (UDR) may be used to perform conditional read or update of the same resource using the If-None-Match or If-Match headers.

However, with regard to the conditional read or update, there is room for improvement, where conditional transactions with UDR as disclosed herewith may provide such improvement. Therefore, various examples of embodiments described in the subject disclosure provide certain advantages, for example in the form of one or more improvements that are either explicitly described herein or those otherwise apparent to a person skilled in the art from the subject disclosure.

At least some example embodiments may pertain to an Etag header in a GET response from UDR as indicated above. In certain examples of embodiments, the Etag header may be used to perform conditional read or update of the same resource using the If-None-Match or If-Match headers.

UDR may be configured to support a GET of multiple sub-resources using a parent resource Uniform Resource Identifier (URI) for optimized data retrieval (e.g., efficient data retrieval). For example, GET context-data using context-dataset-names, GET all ee subscriptions, may be employed.

However, subsequent conditional reads or updates of sub-resources by NF consumers (NFC) is not possible as the Etag value returned in the GET response is not applicable to sub-resources.

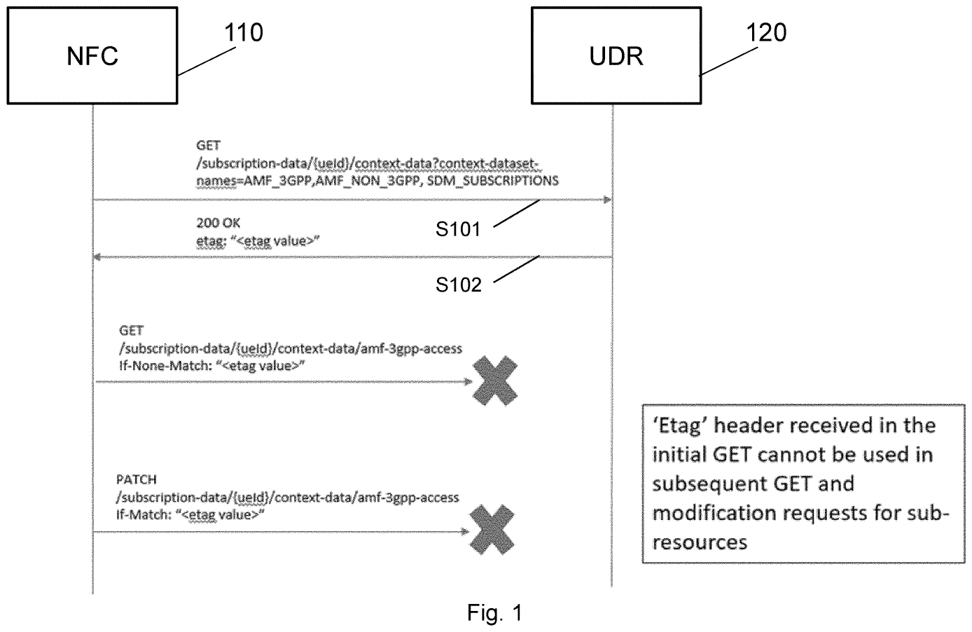

In particular, with regard to FIG. 1, in response to the NFC 110 providing, in S101, a GET request, the UDR 120 provides, in S102, an Etag value to the NFC 110. As illustrated in FIG. 1, such Etag value received by the NFC 110 may not be used in subsequent GET and/or modification requests for sub-resources.

Examples of embodiments described in the subject disclosure provide certain advantages, for example in the form of one or more improvements that are either explicitly described herein or otherwise apparent to a person skilled in the art from the subject disclosure, to address at least part of these drawbacks.

According to at least some examples of embodiments, NF consumers may optionally include a query parameter in the GET request indicating the sub-resources for which Etag values are requested, where the UDR may support including Etag values of sub-resources in the GET response to enable NF consumers to perform (e.g., requested) subsequent conditional read and/or update of sub-resources.

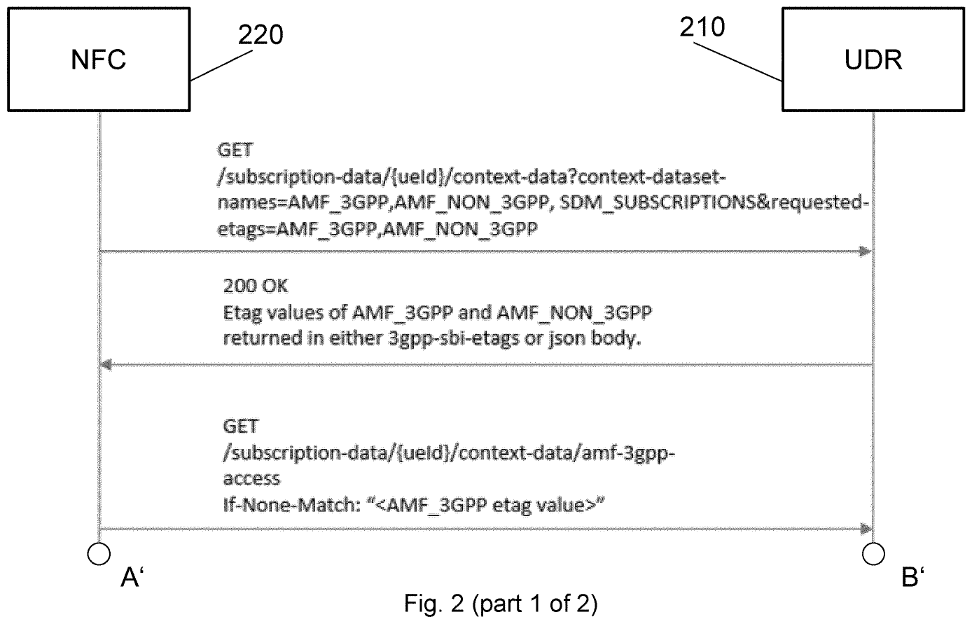

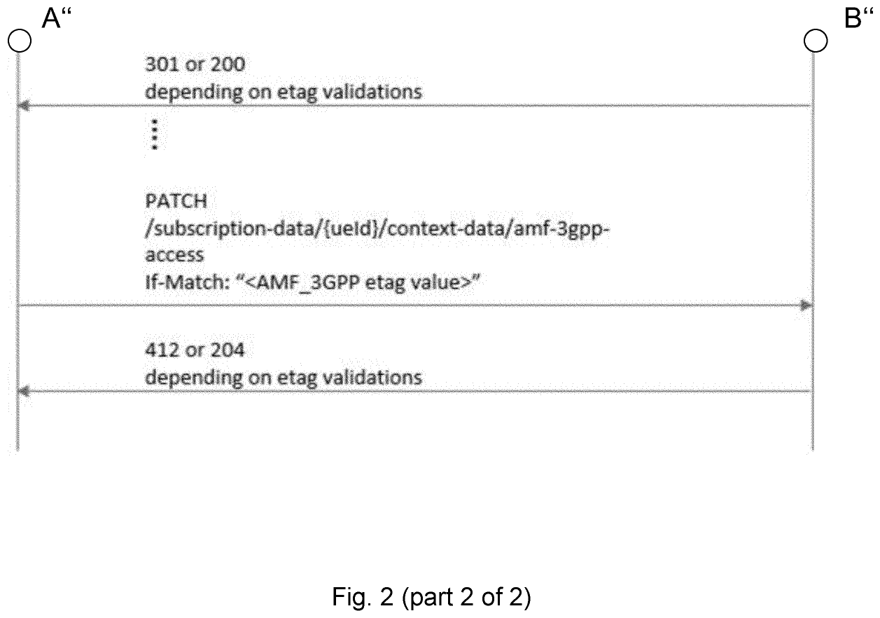

With continued reference to FIG. 2 (including part 1 of 2 and part 2 of 2; to be connected at A′ and A″ as well as B′ and B″), FIG. 2 shows a signaling diagram according to various examples of embodiments of the subject disclosure. In particular, according to some examples of embodiments, several options are illustrated in FIG. 2, which may address at least part of the aforementioned drawbacks.

According to an example of an embodiment, herein referred to as Option 1, the UDR 210, in its response to the NFC 220, is configured to include a map where the URI or other identifier of the resource serves as key and the Etag of the sub-resource serves as the value.

According to another example of an embodiment, herein referred to as Option 2, the UDR 210, in its response to the NFC 220, is configured to include a new header ‘3gpp-sbi-etags’ that packs the requested sub-resources' Etag values.

According to a further example of an embodiment, herein referred to as Option 3, the UDR 210, in its response to the NFC 220, is configured to include an Etag value of each sub-resource in the corresponding resource's object.

According to a yet further example of an embodiment, herein referred to as Option 4, the UDR 210, in its response to the NFC 220, is configured to provide a single Etag header with structured content, such as a JSON map with one member for each sub-resource. The structured content of the Etag in this particular option does not need to be understood by the consumer. A structured Etag can simply be used in an If-Match/If-None-Match header in a subsequent conditional read/update request, because the server would understand the structure of the content and be able to extract the individual sub-resource's Etag to compare to the current Etag.

A possible change to GET of context/provisioned data sets is highlighted in bold below within the following examples of embodiments.

The specific changes to the responses section reflect changes for Option 1 as described above and implemented in the following example of an embodiment.

```
  /subscription-data/{ueId}/{servingPlmnId}/provisioned-data:
  get:
  ....
    parameters:
      ...
    - name: requested-etags:
      in: query
      description: List of sub-resources for which etag values are requested
      style: form
      explode: false
      required: false
      anyOf:
        - type: string
          enum:
            - NONE
            - ALL
            - $ref: ‘#/components/schemas/ProvisionedDataSetName
        - type: array
          items:
            $ref: ‘TS29571_{—}CommonData.yaml#/components/schemas/Uri’
      ....
    responses:
      ‘200’:
        description: Expected response to a valid request
        content:
          application/json:
            schema:
              $ref: ‘#/components/schemas/ProvisionedDataSetsExt’
      default:
        $ref: ‘TS29571_{—}CommonData.yaml#/components/responses/default’
/subscription-data/{ueId}/context-data:
  get:
  ....
    parameters:
              ....
      - name: requested-etags:
        in: query
        description: List of sub-resources for which etag values are requested
        style: form
        explode: false
        anyOf:
        - type: string
          enum:
            - NONE
            - ALL
            - $ref: ‘#/components/schemas/ContextDatasetNames’
        - type: array
          items:
            $ref: ‘TS29571_{—}CommonData.yaml#/components/schemas/Uri’
      ....
    responses:
      ‘200’:
        description: Expected response to a valid request
        content:
          application/json:
            schema:
              $ref: ‘#/components/schemas/ContextDataSetsExt’
      default:
        $ref: ‘TS29571_CommonData.yaml#/components/responses/default’
  ContextDataSetsExt:
    allOf:
      - $ref: ‘#/components/schemas/ContextDataSets’
      - $ref: ‘#/components/schemas/ResourcesEtag’
  ProvisionedDataSetsExt:
    allOf:
      - $ref: ‘#/components/schemas/ProvisionedDataSets’
      - $ref: ‘#/components/schemas/ResourcesEtag’
  ResourcesEtag:
    properties:
      etags:
          description: A map (list of key-value pairs where Uri or other identifier of
          the resource serves as key) of entity tags
        type: object
        additionalProperties:
          type: string
        minProperties: 1
```

For Option 2, as an alternate option, a new 3gpp header called ‘3gpp-sbi-etags’ can be introduced that can be returned in the response, is reflected in the following example of an embodiment.

Simple list form (URI used as resource identifier, but resource name string could be used instead):

3gpp-Sbi-Etags = “3gpp-Sbi-Etags” “:” OWS resourceEtag *(“;”
OWS resourceEtag)
resourceEtag = resourcename “=” entity-tag
resourcename = DQUOTE URI DQUOTE
entity-tag as defined by RFC 7232 section 2.3

Map form (URI used as resource identifier, but resource name string could be used instead):

```
3gpp-Sbi-Etags = “3gpp-Sbi-Etags” “:” OWS etagJSONMap
The etagJSONMap shall be a JSON document containing a single map
object complying to the following OpenAPI specification:
  etagJSONMap:
    description: A map (list of key-value pairs where Uri or other
    identifier of the resource serves as key) of entity tags
    type: object
    additionalProperties:
      type: string
    minProperties: 1
```

For Option 3, adding an Etag as an optional property to existing resources is reflected in the following example of an embodiment. For example:

```
Amf3GppAccessRegistration:
  type: object
  required:
    - amfInstanceId
    - deregCallbackUri
    - guami
    - ratType
  properties:
    amfInstanceId:
      $ref: ‘TS29571_CommonData.yaml#/components/schemas/NfInstanceId’
    etag:
      type: string
```

For Option 4, the UDR 210 may be configured to provide a single Etag header with structured content, such as a JSON map with one member for each sub-resource, in the following example of an embodiment. The Etag header syntax remains the same (as defined by RFC 7232 section 2.3) and the Etagc part complies to the following OpenAPI specification:

```
etagJSONMap:
  description: A map (list of key-value pairs where Uri or other
  identifier of the resource serves as key) of entity tags
  type: object
  additionalProperties:
    type: string
  minProperties: 1
```

In the following, further examples of embodiments are described in relation to the aforementioned methods and/or apparatuses.

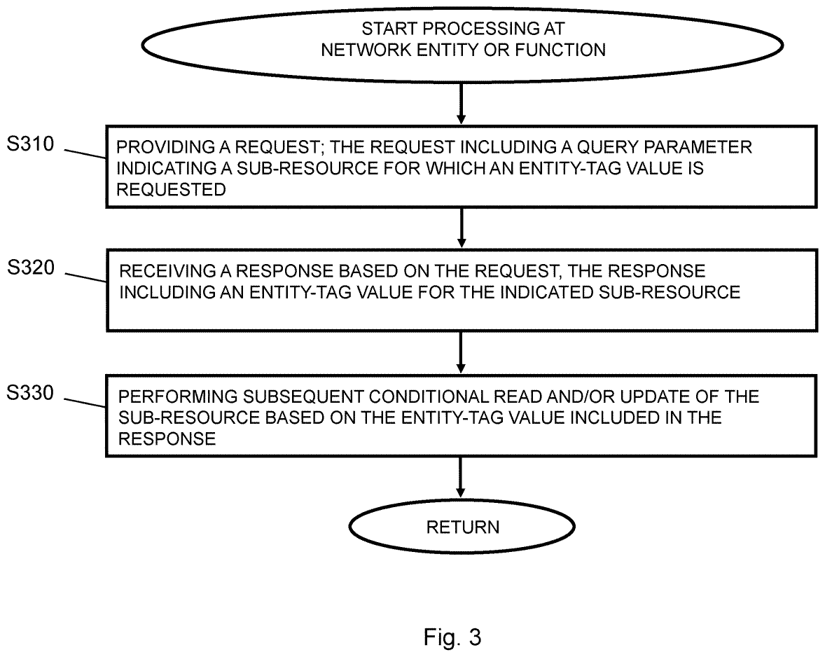

Referring now to FIG. 3, there is shown a flowchart illustrating steps corresponding to an example method according to various examples of embodiments of the subject disclosure. Such method steps may correspond to at least part of such steps as outlined above with reference to Options 1 to 4 and FIG. 2.

In particular, according to FIG. 3, in S310, the method comprises providing a request (e.g., an HTTP request, a GET request, etc.), the request including a query parameter indicating a sub-resource for which an entity-tag value is requested.

Further, in S320, the method comprises receiving a response (e.g., an HTTP response, a GET response) based on the provided request, the response including an entity-tag value for the indicated sub-resource.

Additionally, in S330, the method comprises performing subsequent conditional read and/or update of the sub-resource based on the entity-tag value included in the received response.

It is noted that according to various examples of embodiments of the subject disclosure, the aforementioned method steps S310 to S330 may be applied at/via the NUDR interface. Moreover, it is noted that the aforementioned method may be applied at a network entity or function, (e.g., NFC 220) as outlined-above with reference to Options 1 to 4 and FIG. 2. In addition, such network entity or function may provide the request to (and may receive the response from) another network entity or function, (e.g., UDR 210) as outlined-above with reference to Options 1 to 4 and FIG. 2.

Moreover, according to at least some examples of embodiments, the request may be an HTTP request and the response may be an HTTP response.

Furthermore, according to various examples of embodiments, the request may be a GET request and the response may be a GET response.

Moreover, according to at least some examples of embodiments, the method may comprise that the providing comprises including the query parameter in the request.

Furthermore, according to various examples of embodiments, the method may comprise that the providing comprises providing the request for a resource, wherein the sub-resource for which the entity-tag value is requested is a sub-resource of the resource.

The aforementioned examples of embodiments may thus, for instance, realize an increased efficiency, by optimized (e.g. efficient) use of Etags for conditional reads and/or updates. Therefore, the aforementioned solution may provide certain advantages in that it enables for optimized (e.g., efficient and/or secure and/or robust and/or failure resistant and/or flexible) conditional transactions with a network entity or function (e.g., UDR).

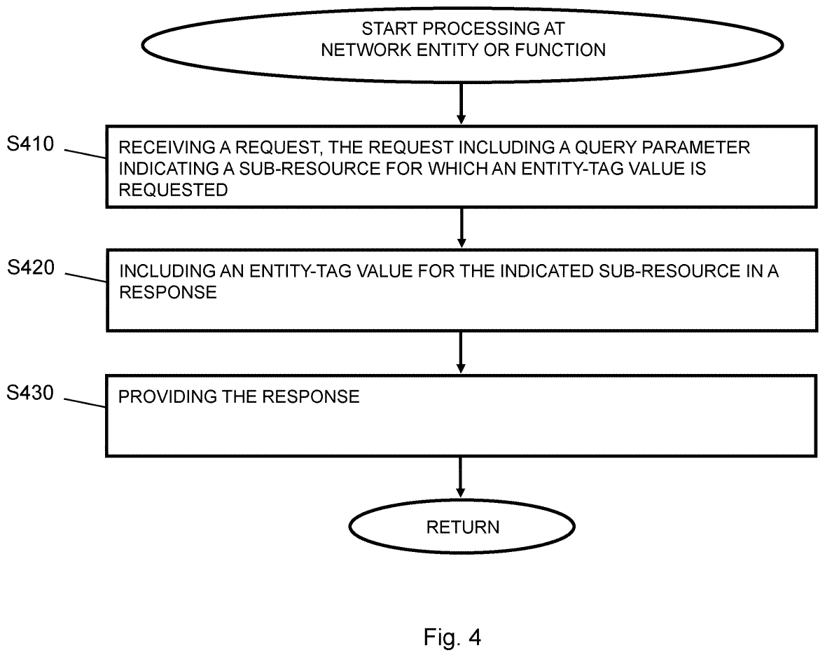

Referring now to FIG. 4, FIG. 4 shows a flowchart illustrating steps corresponding to an example method according to various examples of embodiments of the subject disclosure. Such method steps may correspond to at least part of such steps as outlined above with reference to Options 1 to 4 and FIG. 2.

In particular, according to FIG. 4, in S410, the method comprises receiving a request (e.g., HTTP request, GET request, etc.), the request including a query parameter indicating a sub-resource for which an entity-tag value is requested.

Further, in S420, the method comprises including an entity-tag value for the indicated sub-resource in a response (e.g., HTTP response, GET response, etc.).

Additionally, in S430, the method comprises providing the response.

It is noted that according to various examples of embodiments of the subject disclosure, the aforementioned method steps S410 to S430 may be applied at/via the NUDR interface. Moreover, it is noted that the aforementioned method may be applied at a network entity or function, (e.g., UDR 210) as outlined-above with reference to Options 1 to 4 and FIG. 2. In addition, such network entity or function may provide the response to (and may receive the request from) another network entity or function (e.g., NFC 220) as outlined-above with reference to Options 1 to 4 and FIG. 2.

Moreover, according to at least some examples of embodiments, the request may be an HTTP request and the response may be an HTTP response.

Furthermore, according to various examples of embodiments, the request may be a GET request and the response may be a GET response.

Moreover, according to at least some examples of embodiments, the method may further comprise that the receiving comprises receiving the request for a resource, wherein the sub-resource for which the entity-tag value is requested is a sub-resource of the resource.

Furthermore, according to various examples of embodiments, the method may further comprise that the including comprises including a map in the response, where an identifier of a resource for which the request is received, the resource comprising the sub-resource, serves as key and where an entity-tag of the sub-resource serves as the entity-tag value.

In addition, according to at least some examples of embodiments, the method may further comprise that the including comprises introducing and/or updating a header in the response to comprise the entity-tag value corresponding to the indicated sub-resource.

Optionally, according to various examples of embodiments, the method may further comprise that the introduced and/or updated header is in list form or in map form.

Further, according to at least some examples of embodiments, the method may further comprise that the including comprises including, in the response, an entity-tag value of each sub-resource in a corresponding resource for which the request is received.

Moreover, according to various examples of embodiments, the method may further comprise that the providing comprises providing a single entity-tag header with structured content comprising at least one member for each sub-resource in a corresponding resource for which the request is received.

The aforementioned examples of embodiments may thus, for instance, realize an increased efficiency, by optimized (e.g., efficient) use of Etags for conditional reads and/or updates. Therefore, the aforementioned solution may provide certain advantages in that it enables for optimized (e.g., efficient and/or secure and/or robust and/or failure resistant and/or flexible) conditional transactions with a network entity or function (e.g., UDR).

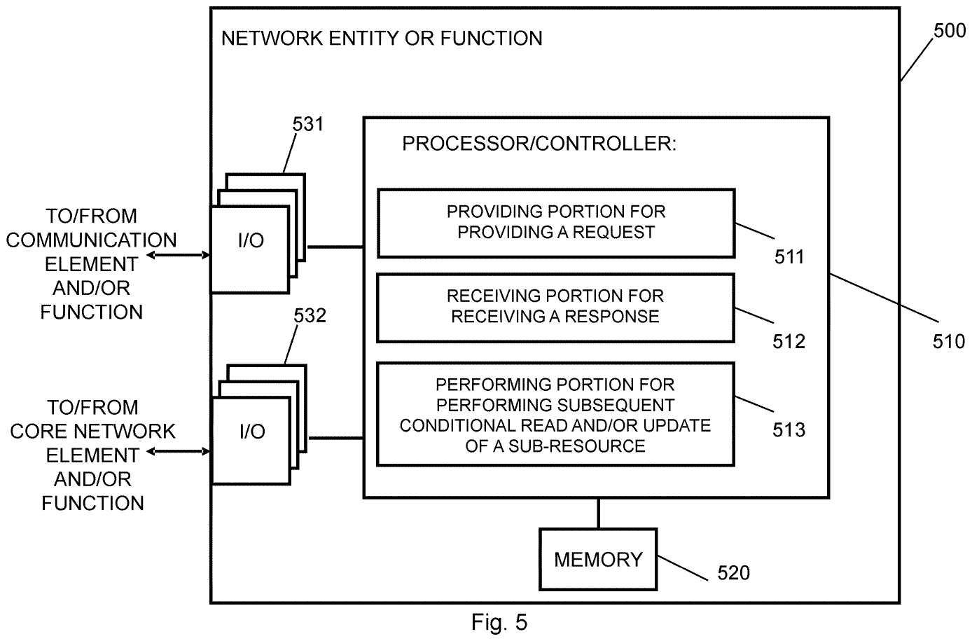

Referring now to FIG. 5, FIG. 5 shows a block diagram illustrating an example apparatus according to various examples of embodiments of the subject disclosure.

Specifically, FIG. 5 shows a block diagram illustrating an apparatus 500, which may represent a network entity or function, (e.g. NFC 220) as outlined above with reference to Options 1 to 4 and FIG. 2, according to various examples of embodiments, which may participate in conditional transactions with another network entity or function (e.g., UDR). Furthermore, even though reference is made to a network entity or function, the network entity or function may be also another device or function having a similar task, such as a chipset, a chip, a module, an application etc., which can also be part of a network element or attached as a separate element to a network element, or the like. It should be understood that each block and any combination thereof may be implemented by various means or their combinations, such as hardware, software, firmware, one or more processors and/or circuitry.

The apparatus 500 shown in FIG. 5 may include a processing circuitry, a processing function, a control unit or a processor 510, such as a CPU or the like, which is suitable to enable conditional transactions with a network entity or function (e.g., UDR). The processor 510 may include one or more processing portions or functions dedicated to specific processing as described below, or the processing may be run in a single processor or processing function. Portions for executing such specific processing may be also provided as discrete elements or within one or more further processors, processing functions or processing portions, such as in one physical processor like a CPU or in one or more physical or virtual entities, for example. Reference signs 531 and 532 denote input/output (I/O) units or functions (interfaces) connected to the processor or processing function 510. The I/O units 531 and 532 may be a combined unit including communication equipment towards several entities/elements, or may include a distributed structure with a plurality of different interfaces for different entities/elements. Reference sign 520 denotes a memory usable, for example, for storing data and programs to be executed by the processor or processing function 510 and/or as a working storage of the processor or processing function 510. It is to be noted that the memory 520 may be implemented by using one or more memory portions of the same or different type of memory, but may also represent an external memory, e.g. an external database provided on a cloud server.

The processor or processing function 510 is configured to execute processing related to the above described processing. In particular, the processor or processing circuitry or function 510 includes one or more of the following sub-portions. Sub-portion 511 is a providing portion, which is usable as a portion for providing a request (e.g., an HTTP request, a GET request, etc.). The portion 511 may be configured to perform processing according to S310 of FIG. 3. Further, sub-portion 512 is a receiving portion, which is usable as a portion for receiving a response (e.g., an HTTP response, a GET response, etc.). The portion 512 may be configured to perform processing according to S320 of FIG. 3. Moreover, sub-portion 513 is a performing portion, which is usable as a portion for performing subsequent conditional read and/or update of a sub-resource. The portion 513 may be configured to perform processing according to S330 of FIG. 3.

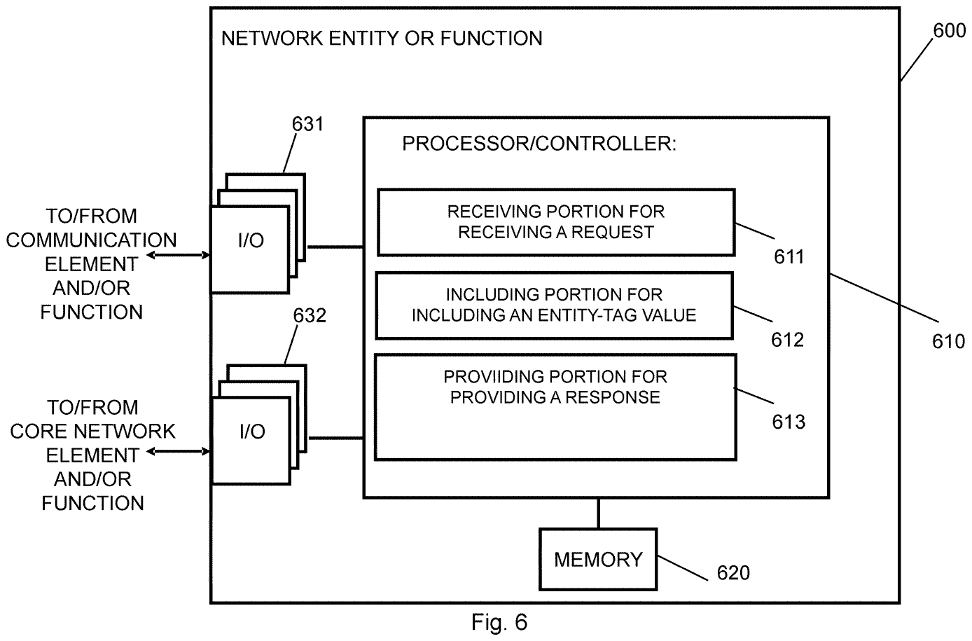

Referring now to FIG. 6, FIG. 6 shows a block diagram illustrating an example apparatus according to various examples of embodiments of the subject disclosure.

Specifically, FIG. 6 shows a block diagram illustrating an apparatus 600, which may represent a network entity or function, (e.g., UDR 210) as outlined above with reference to Options 1 to 4 and FIG. 2, according to various examples of embodiments, which may participate in conditional transactions with a network entity or function (e.g., UDR). Furthermore, even though reference is made to a network entity or function, the network entity or function may be also another device or function having a similar task, such as a chipset, a chip, a module, an application etc., which can also be part of a network element or attached as a separate element to a network element, or the like. It should be understood that each block and any combination thereof may be implemented by various means or their combinations, such as hardware, software, firmware, one or more processors and/or circuitry.

The apparatus 600 shown in FIG. 6 may include a processing circuitry, a processing function, a control unit or a processor 610, such as a CPU or the like, which is suitable to enable conditional transactions with a network entity or function (e.g., UDR). The processor 610 may include one or more processing portions or functions dedicated to specific processing as described below, or the processing may be run in a single processor or processing function. Portions for executing such specific processing may be also provided as discrete elements or within one or more further processors, processing functions or processing portions, such as in one physical processor like a CPU or in one or more physical or virtual entities, for example. Reference signs 631 and 632 denote input/output (I/O) units or functions (interfaces) connected to the processor or processing function 610. The I/O units 631 and 632 may be a combined unit including communication equipment towards several entities/elements, or may include a distributed structure with a plurality of different interfaces for different entities/elements. Reference sign 620 denotes a memory usable, for example, for storing data and programs to be executed by the processor or processing function 610 and/or as a working storage of the processor or processing function 610. It is to be noted that the memory 620 may be implemented by using one or more memory portions of the same or different type of memory, but may also represent an external memory, e.g. an external database provided on a cloud server.

The processor or processing function 610 is configured to execute processing related to the above described processing. In particular, the processor or processing circuitry or function 610 includes one or more of the following sub-portions. Sub-portion 611 is a receiving portion, which is usable as a portion for receiving a request (e.g., an HTTP request, a GET request, etc.). The portion 611 may be configured to perform processing according to S410 of FIG. 4. Further, sub-portion 612 is an including portion, which is usable as a portion for including an entity-tag, Etag, value in a response (e.g., an HTTP response, a GET response, etc.). The portion 612 may be configured to perform processing according to S420 of FIG. 4. Moreover, sub-portion 613 is a providing portion, which is usable as a portion for providing the response. The portion 613 may be configured to perform processing according to S430 of FIG. 4.

It shall be noted that the apparatuses 500 and 600 as outlined above with reference to FIGS. 5 and 6 may comprise further/additional sub-portions, which may allow the apparatuses 500 and 600 to perform such methods/method steps as outlined above with reference to FIGS. 2 to 4.

It should be appreciated that
an access technology via which traffic is transferred to and from an entity in the communication network may be any suitable present or future technology, such as WLAN (Wireless Local Access Network), WiMAX (Worldwide Interoperability for Microwave Access), LTE, LTE-A, 5G, 6G, Bluetooth, Infrared, and the like may be used; additionally, examples of embodiments may also apply wired technologies, e.g. IP based access technologies like cable networks or fixed lines.
examples of embodiments suitable to be implemented as software code or portions thereof and being run using a processor or processing function are software code independent and can be specified using any known or future developed programming language, such as a high-level programming language, such as objective-C, C, C++, C#, Java, Python, Javascript, other scripting languages etc., or a low-level programming language, such as a machine language, or an assembler.
implementation of examples of embodiments is hardware independent and may be implemented using any known or future developed hardware technology or any hybrids of these, such as a microprocessor or CPU (Central Processing Unit), MOS (Metal Oxide Semiconductor), CMOS (Complementary MOS), BiMOS (Bipolar MOS), BiCMOS (Bipolar CMOS), ECL (Emitter Coupled Logic), and/or TTL (Transistor-Transistor Logic).
examples of embodiments may be implemented as individual devices, apparatuses, units, means or functions, or in a distributed fashion, for example, one or more processors or processing functions may be used or shared in the processing, or one or more processing sections or processing portions may be used and shared in the processing, wherein one physical processor or more than one physical processor may be used for implementing one or more processing portions dedicated to specific processing as described,
an apparatus may be implemented by a semiconductor chip, a chipset, or a (hardware) module including such chip or chipset;
examples of embodiments may also be implemented as any combination of hardware and software, such as ASIC (Application Specific IC (Integrated Circuit)) components, FPGA (Field-programmable Gate Arrays) or CPLD (Complex Programmable Logic Device) components or DSP (Digital Signal Processor) components.
examples of embodiments may also be implemented as computer program products, including a computer usable medium having a computer readable program code embodied therein, the computer readable program code adapted to execute a process as described in embodiments, wherein the computer usable medium may be a non-transitory medium.

The term “circuitry” may refer to one or more or all of the following examples of embodiments:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and hardware circuit(s) and or processor(s), such as a microprocessor(s) or a portion of a microprocessor(s), that requires software (e.g., firmware) for operation, but the software may not be present when it is not needed for operation.”

This definition of circuitry applies to all uses of this term herein, including in any claims. As a further example, as used herein, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The term “non-transitory,” as used herein, is a limitation of the medium itself (e.g., tangible, not a signal) as opposed to a limitation on data storage persistency (e.g., RAM vs. ROM).

As used herein, “at least one of the following:” and “at least one of” and similar wording, where the list of two or more elements are joined by “and” or “or”, mean at least any one of the elements, or at least any two or more of the elements, or at least all the elements.

Although the subject disclosure has been described herein before with reference to various examples of embodiments thereof, the subject disclosure is not limited thereto and it will be apparent to a person skilled in the art that various modifications can be made to the subject disclosure.

### Abbreviations

The following meanings for the abbreviations used herein apply:
3GPP 3^{rd} Generation Partnership Project
3GGP2 3^{rd} Generation Partnership Project 2
4G Fourth Generation
5G Fifth Generation
6G Sixth Generation
AP Access Point
AP Application Programming Interface
BS Base Station
CDMA Code Division Multiple Access
NB Evolved Node B
Etag entity-tag
ETSI European Telecommunications Standards Institute
gNB Next Generation Node B
IEEE Institute of Electrical and Electronics Engineers
ITU International Telecommunication Union
LTE Long Term Evolution
LTE-A Long Term Evolution-Advanced
MANETs Mobile Ad-Hoc Networks
NB Node B
NF Network Function
NFC Network Function Consumer
NUDR Network Unified Data Repository
RAM Random Access Memory
RAN Radio Access Network
ROM Read Only Memory
TISPAN Telecoms & Internet converged Services & Protocols for Advanced Networks
UE User Equipment
UDM Unified Data Management Services
UDR Unified Data Repository
UWB Ultra-Wideband
WCDMA Wideband Code Division Multiple Access
WiMAX Worldwide Interoperability for Microwave Access
WLAN Wireless Local Area Network

1-30. (canceled)

31. An apparatus, comprising
at least one processor; and
at least one memory storing instructions that, when executed by the at least one processor, cause the apparatus at least to:
provide a request, the request including a query parameter indicating a sub-resource for which an entity-tag value is requested;
receive a response based on the request, the response including an entity-tag value for the indicated sub-resource; and
perform subsequent conditional read and/or update of the sub-resource based on the entity-tag value included in the response.

32. The method according to claim 31, wherein the request is an HTTP request and the response is an HTTP response.

33. The apparatus according to claim 31, wherein the request is an HTTP GET request, and the response is an HTTP GET response.

34. The apparatus according to claim 31, wherein the instructions, when executed by the at least one processor, further cause the apparatus at least to:
provide the request comprises to include the query parameter in the request.

35. The apparatus according to claim 31, wherein the instructions, when executed by the at least one processor, further cause the apparatus at least to:
provide the request comprises to provide the request for a resource, wherein the sub-resource for which the entity-tag value is requested is a sub-resource of the resource.

36. An apparatus, comprising
at least one processor; and
at least one memory storing instructions that, when executed by the at least one processor, cause the apparatus at least to:
receive a request, the request including a query parameter indicating a sub-resource for which an entity-tag value is requested;
include an entity-tag value for the indicated sub-resource in a response; and
provide the response.

37. The method according to claim 36, wherein the request is an HTTP request and the response is an HTTP response.

38. The apparatus according to claim 36, wherein the request is an HTTP GET request and the response is an HTTP GET response.

39. The apparatus according to claim 36, wherein the instructions, when executed by the at least one processor, further cause the apparatus at least to:
receive the request comprises to receive the request for a resource,
wherein the sub-resource for which the entity-tag value is requested is a sub-resource of the resource.

40. The apparatus according to claim 36, wherein the instructions, when executed by the at least one processor, further cause the apparatus at least to:
include the entity-tag value comprises to include a map in the response,
where an identifier of a resource for which the request is received, the resource comprising the sub-resource, serves as key and
where an entity-tag of the sub-resource serves as the entity-tag value.

41. The apparatus according to claim 36, wherein the instructions, when executed by the at least one processor, further cause the apparatus at least to:
include the entity-tag value comprises to introduce and/or update a header in the response to comprise the entity-tag value corresponding to the indicated sub-resource.

42. The apparatus according to claim 41, wherein the introduced and/or updated header is in list form or in map form.

43. The apparatus according to claim 36, wherein the instructions, when executed by the at least one processor, further cause the apparatus at least to:
include the entity-tag value comprises to include, in the response, an entity-tag value of each sub-resource in a corresponding resource for which the request is received.

44. The apparatus according to claim 36, wherein the instructions, when executed by the at least one processor, further cause the apparatus at least to:
provide the entity-tag value comprises to provide a single entity-tag header with structured content comprising at least one member for each sub-resource in a corresponding resource for which the request is received.

45. A method comprising,
providing a request, the request including a query parameter indicating a sub-resource for which an entity-tag value is requested;
receiving a response based on the request, the response including an entity-tag value for the indicated sub-resource; and
performing subsequent conditional read and/or update of the sub-resource based on the entity-tag value included in the response.

46. The method according to claim 45, wherein the request is an HTTP request and the response is an HTTP response.

47. The method according to claim 45, wherein the request is an HTTP GET request and the response is an HTTP GET response.

48. The method according to claim 45, wherein the providing comprises:
including the query parameter in the request.

49. The method according to claim 45, wherein the providing comprises:
providing the request for a resource,
wherein the sub-resource for which the entity-tag value is requested is a sub-resource of the resource.
